(19) United States
(12) Patent Application Publication
(10) Pub. No.: US 2011/0238347 A1
(43) Pub. Date: Sep. 29, 2011

(54) APPARATUS AND SYSTEM FOR AUTOMATED PIPELINE TESTING

(75) Inventors: Karl Bernhard Gemperli, Leawood, KS (US); James Rutledge Hilleary, Mission, KS (US); Michael Reed, Shawnee, KS (US)

(73) Assignee: Elecsys Corporation, Olathe, KS (US)

(21) Appl. No.: 13/053,970

(22) Filed: Mar. 22, 2011

Related U.S. Application Data
(60) Provisional application No. 61/317,128, filed on Mar. 24, 2010.

(51) Int. Cl. G06F 19/00

(52) U.S. Cl. 702/65

(57) ABSTRACT

A cathodic protection system comprising remote test units for measuring various voltages and currents at remote locations on a cathodically-protected pipeline. The remote test units may comprise a processor configured to store measurements taken with the voltmeter and a wireless transceiver for communicating with other test units and/or a Web server or host computer in a daisy-chain or mesh radio configuration. The remote test units may comprise an instant-off switch which electrically connects the pipeline with a buried protected coupon of the same material as the pipeline, and a voltmeter configured to measure the instant-off potential of the protected coupon when the switch is opened. The test units may also comprise a millivoltmeter configured to measure a voltage across a critical bond current shunt resistor and an ammeter configured to measure AC and DC current flowing between the pipeline and the protected coupon with the instant-off switch is closed.

### RELATED APPLICATIONS

The present utility patent application claims priority benefit, with regard to all common subject matter, of the earlier-filed U.S. provisional patent application titled “Apparatus and System for Automated Pipeline Testing” Ser. No. 61/317,128, filed Mar. 24, 2010, hereby incorporated in its entirety by reference into the present application.

### BACKGROUND

1. Field

The present invention generally relates to underground metal structures, such as pipelines, and more specifically to apparatuses monitoring cathodic protection applied to such structures.

2. Prior Art

Pipelines and other metallic structures are generally subject to corrosion when buried underground. The corrosion process involves the removal of electrons or oxidation of the metal and consumption of those electrons by some other reduction reaction, such as oxygen or water reduction. Corrosion is encouraged by the presence of moist soil in contact with a metal pipeline.

Methods for mitigating corrosion of underground structures such as pipelines include the application of external voltages and currents to neutralize the voltages and currents associated with the corrosion process. For example, one known electrical corrosion prevention system for application of external voltages and currents to an underground structure or pipeline is referred to as a cathodic protection system. A cathodic protection system typically includes a plurality of cathodic protection rectifiers, which are located along the structure or pipeline and configured to apply a cathodic protection current to the structure or pipeline.

Methods for assessing the performance of a cathodic protection system include obtaining several voltage potential measurements between a cathodically protected metal structure (such as a pipe) and a reference electrode (reference cell or half cell), commonly referred to as pipe to soil measurements at test points along the pipeline with the cathodic protection rectifiers turned on and with the cathodic protection rectifiers turned off. One test measures something called an “instant off” potential from the pipe to an electrical ground or reference cell buried in the nearby soil. The instant off potential is measured at each of the test points 100 milliseconds to 1,000 milliseconds after all cathodic protection rectifiers affecting the test point have been simultaneously turned off. Current methods of obtaining the instant off potential at various test points require a high level of synchronization, so that the cathodic protection rectifiers may be simultaneously shut off and so that the measurements at the test points are taken, either by remote testing equipment or manually by survey crews, within the desired window of time.

### SUMMARY

Embodiments of the present invention disclose a system for monitoring cathodic protection applied to an underground pipeline at remote test unit locations. The system may comprise one or more test units having at least one voltmeter, a switch for electrically coupling and decoupling a buried protected coupon to and from the buried pipeline, and a processor communicatively coupled to the voltmeter and the switch. The voltmeter may be configured to obtain measurements of AC and/or DC potential between a first input and a reference cell. The first input may be connected to the pipeline, an unprotected coupon buried next to the structure, and the protected coupon buried next to the structure.

The processor may be configured to command the switch to actuate from a closed position to an open position, disrupting the cathodic protection current flowing between the pipeline and the protected coupon. The processor may also store or transmit a measurement of a potential (i.e., instant-off potential) between the protected coupon and the reference cell taken with the voltmeter at a predetermined interval of time after the switch is opened. The predetermined interval of time may be between approximately 100 milliseconds and 10 seconds.

Each of the test units may also comprise a wireless transmitter configured to send and receive signals wirelessly with at least one of other test units, a Web server, or a host computer. In some embodiments of the invention, the test units may be communicatively coupled in a daisy-chain or mesh radio network configuration. For example, at least some of the test units may be concentrator units configured to communicate via short-range wireless signals with others of the test units and via long-range wireless signals with the Web server or host computer. Additionally, at least some of the test units may be field units configured to only communicate via short-range wireless signals with others of the test units in a close proximity thereto. Specifically, the long-range wireless signals comprise cellular, GSM, satellite, TCP/IP, data radio, and other data telemetry signals, and the short-range wireless signals comprise local area radio signals or very high frequency (VHF) radio signals.

A method of the present invention for monitoring cathodic protection of a buried pipeline at a particular point on the pipeline may comprise a step of automatically sending a signal from a processor of a remote test unit to a switch electrically connecting the pipeline with a protected coupon buried close to the pipeline. The signal may be configured for instructing the switch to open, interrupting current flow between the pipeline and the protected coupon. The method may also comprise a step of storing a measurement of AC and/or DC potential between the protected coupon and a reference cell taken a pre-determined interval of time after instructing the switch to open. For example, the predetermined interval of time may be between approximately 100 milliseconds to 10 seconds after the switch is instructed to open. Additionally, the method may comprise a step of transmitting the measurement of the potential between the protected coupon and the reference cell to a Web server or host computer. The Web server or host computer may be configured to present the measurement of the potential between the protected coupon and the reference cell to a user via a Web browser.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram of a system for monitoring cathodic protection of a buried pipeline;

FIG. 2 is a schematic diagram of a test unit of the system of FIG. 1 and its various inputs;

FIG. 3 is a schematic diagram of the test unit of FIG. 2, further illustrating inputs as well as data and current flow between components of the test unit;

FIG. 4 is a schematic diagram of the system of FIG. 1 illustrating mesh network communication between multiple test units of the system; and

FIG. 5 is a flow chart of a method, according to various embodiments of the present invention, of monitoring cathodic protection at a remote location on a buried pipeline.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

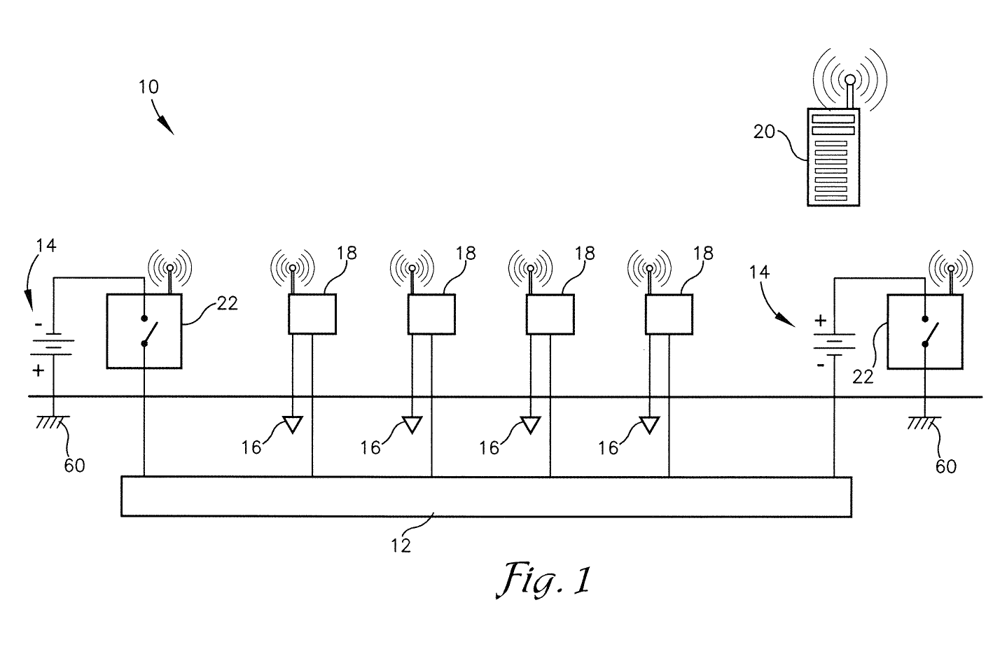

The present invention, as illustrated in FIG. 1, provides a system 10 and method for testing cathode protection (CP) of a buried structure, such as a buried pipeline 12. For example, cathodic protection rectifiers 14 may be placed along the pipeline 12 every three to five miles and used to apply a voltage across an anode ground bed 60 in the soil and the pipeline 12. The pipeline 12, as described herein, may be any structure susceptible to corrosion and capable of having cathodic protection applied thereto. Additionally or alternatively, the pipeline 12, as used in systems and methods described herein, may be replaced with other cathodically protected structures such as the interior surfaces of above ground storage tanks or the base surfaces of tanks that contact the earth and require cathodic protection, though they may not necessarily be buried structures, per se. The voltage applied for cathodic protection may be approximately equal to and oppositely polarized to a voltage that naturally occurs between the pipeline 12 and the soil it contacts due to galvanic corrosion and is believed to minimize a rate of corrosion. Note that the cathodic protection rectifiers 14, as used herein, may refer to any impressed current generating device, such as an AC-to-DC transformer/rectifier, a solar powered DC current generator, a thermoelectric generator, a fuel-cell based current generating device, or any device used to apply cathodic protection current to a structure.

The system 10 may also comprise a plurality of remote test units 18 electrically coupled to the pipeline 12 and each having a reference cell 16 (i.e., electrical ground) associated therewith. The remote test units 18 may be configured for automated testing and monitoring of the pipeline 12 at various remote locations. Furthermore, the remote test units 18 may be configured to send and receive data wirelessly to and from a Web server or host computer 20, as illustrated in FIG. 1. For example, data from the remote test units 18 may be uploaded to a Web site which may be accessed via a personal computer, laptop, mobile phone, or any other apparatus known in the art for connecting to the Internet and displaying Web sites, as later described herein.

The Web server or host computer 20 may comprise any number or combination of controllers, circuits, integrated circuits, programmable logic devices, computers, processors, microcontrollers, or other control devices and residential or external memory for storing data and other information input by a user or received by any of the test units 18. The host computer 20 may have one or more components distributed among several different computers or servers at multiple locations communicatively coupled with each other and/or the test units 18 through wired or wireless connections, such as a data bus (not shown), to enable information to be exchanged between the various components.

In some embodiments of the invention, the Web server or host computer 20 may implement a computer program, executable computer code, and/or code segments to perform some of the functions and method described herein. The computer program may comprise an ordered listing of executable instructions for implementing logical functions in the control system. The computer program can be embodied in any computer-readable medium for use by or in connection with an instruction execution system, apparatus, or device, and execute the instructions. In the context of this application, a “computer-readable medium” can be any means that can contain or store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The computer program may comprise executable computer code related to displaying information from the test units 18 via a personal computer, laptop, mobile phone, or any other apparatus known in the art for connected to the Internet and displaying Web sites. Furthermore, the executable computer code stored in the residential or external memory may be configured to make calculations related to cathodic protection monitoring based on measurements transmitted by the test units and received by the Web server or host computer 20. For example, the executable computer code may be configured for calculating a current density value, as later described herein.

In some embodiments of the invention, one or more of the test units 18 and/or the host computer 20 may be communicatively coupled with cathodic system monitors 22, such as the cathodic system monitors described in U.S. Pat. No. 7,068,052, incorporated by reference herein in its entirety. The cathodic system monitors 22, as illustrated in FIG. 1, may be configured to switch voltage output from the cathodic protection rectifiers 14 to the pipeline 12 on and off, as well as monitor and/or control the cathodic protection rectifiers 14 providing cathodic protection to the pipeline 12. In some embodiments of the invention, at least one of the cathodic system monitors 22 may be associated with each cathodic protection rectifier 14.

The cathodic system monitor 22 may be configured to test the cathodic rectifiers 14 by measuring potentials or voltages and currents output by the rectifiers 14 and delivering or transmitting the measurement data to an external system, such as the host computer 20, the Web server, a centralized database, or a data center, then allowing access to the measurement data via a Web site displayed via a Web browser. The cathodic system monitor 22 may also be configured to receive instructions or data requests via a Web site or other Web-user interface from the Web server or host computer 20 and then output instructions or data requests to any of the test units 18 wirelessly.

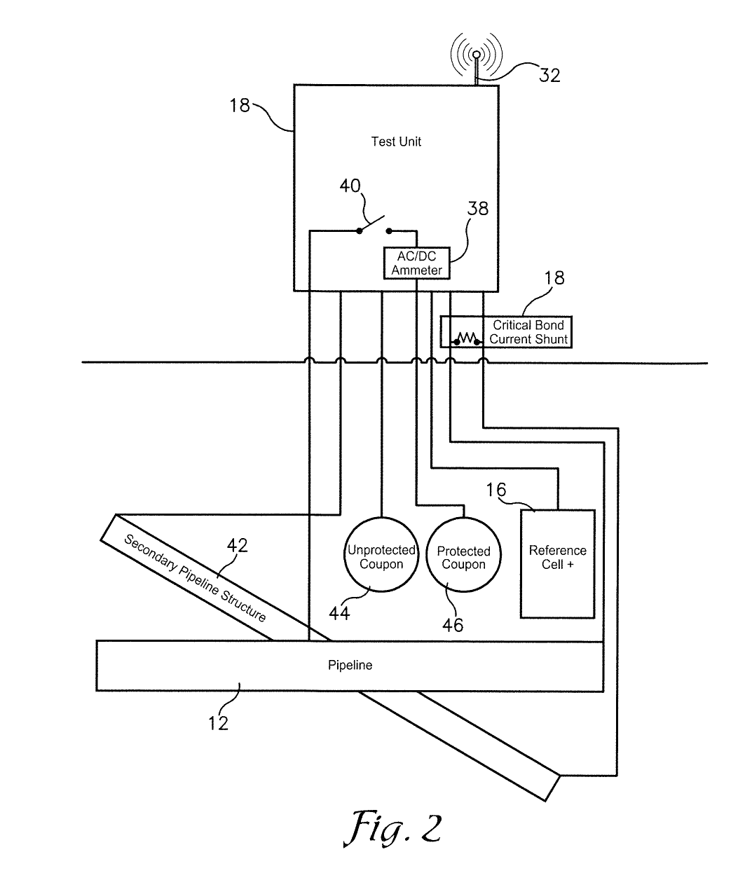

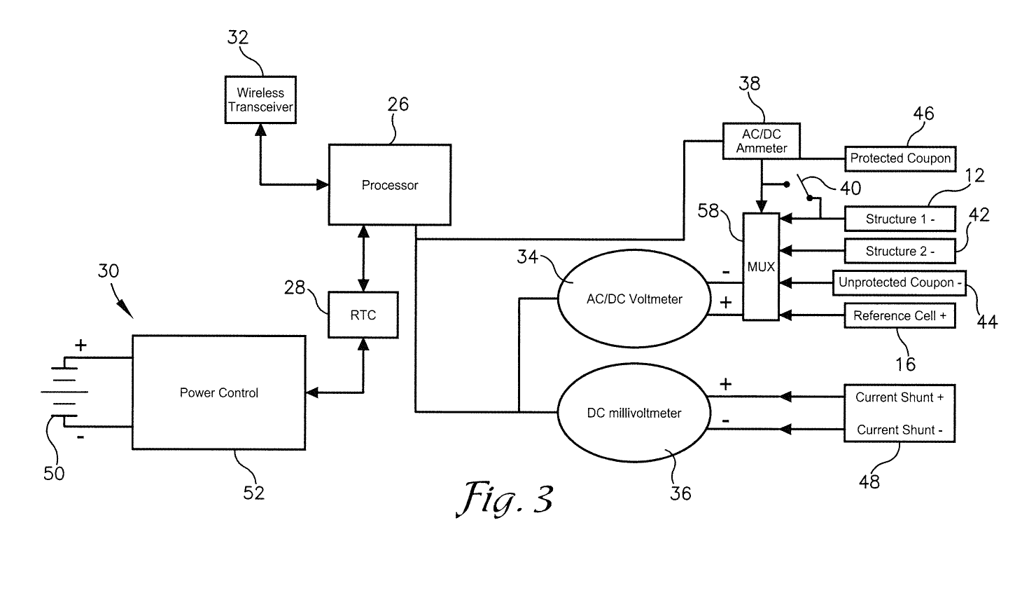

The remote test units 18 may be spaced along the pipeline 12 and configured to read pipe-to-soil potentials or voltages induced by the cathodic protection rectifiers 14. In some embodiments of the invention, the remote test units 18 may be used in conjunction with, in place of, or to enhance the capabilities of the test point monitors described in U.S. Pat. No. 7,068,052, as previously incorporated herein. The test units 18 may be located outdoors and encased in a weather-resistant housing, such as a heavy-duty plastic or fiberglass housing. As illustrated in FIG. 3, each of the test units 18 may comprise a processor 26, a real time clock 28, a power source 30, a wireless transceiver 32, one or more voltmeters 34,36, an AC/DC ammeter 38, and/or an instant-off switch 40, as later described herein. As illustrated in FIGS. 2-3, the test units 18 may also comprise and/or be electrically connected to the pipeline 12, a secondary pipeline structure 42, an unprotected coupon 44, a protected coupon 46, the reference cell 16 (i.e., electrical ground), and/or a critical bond current shunt resistor 48.

The secondary pipeline structure 42, as illustrated in FIG. 2, may be any nearby pipeline or other structure capable of inducing current onto the pipeline 12. For example, the pipeline 12 may be adjacent to or near other structures, such as the secondary pipeline structure 42 which have ground contact and are therefore subject to corrosion. Cathodic protection may be provided for these adjacent structures, which may interfere electrically with the cathode protection of the pipeline 12. The interference may be manifested as undesired currents flowing between the pipeline 12 and the secondary pipeline structure 42. To control such currents, a shunt resistance, such as the critical bond current shunt resistor 48, may be placed between the pipeline 12 and the secondary pipeline structure 42. The critical bond current shunt resistor 48 may have any resistive value, but in some embodiments of the invention, the critical bond current shunt resistor 48 may be within a range of approximately 0.25 milliohms to 10 milliohms. For example, the critical bond current shunt resistor 48 may be approximately 1 milliohm. Testing of the critical bond current shunt resistor 48 ensures that the corrosion mitigation processes in place continue to be effective, and verifies that the current path between the pipeline 12 and the secondary pipeline structure 42 has not been opened. In some embodiments of the invention, where no secondary pipeline structure is present, the critical bond current shunt resistor 42 and inputs to measure the potential thereon may be omitted from any of the remote test units 18 if not required at a particular test unit location. Alternatively, these inputs may be provided but remain unused by the remote test unit 18.

A coupon is defined herein as a piece of material of a known surface area made of the same alloy as the pipeline 12. The unprotected coupon 44 may be a bare piece of metal of the same alloy as the pipeline 12 and buried next to the pipeline 12. The unprotected coupon 44 is not cathodically protected, and therefore simulates a bare spot or “holiday” in the pipeline's protective coating. The potential of the unprotected coupon 44, relative to the reference cell 16, is indicative of the pipeline's natural state. The protected coupon 46 may also be a piece of metal of the same alloy as the pipeline 12 and buried next to the pipeline 12. However, the protected coupon 46 may be shorted to the pipeline 12 via a wire, cable, or some other means so that it receives the same cathodic protection as the pipeline 12. For example, the protected coupon 46 may be shorted to the pipeline 12 via the instant-off switch 40, as later described herein.

The processor 26 of each test unit 18 may comprise any number or combination of controllers, circuits, integrated circuits, programmable logic devices, computers, processors, microcontrollers, or other control devices and residential or external memory for storing data and other information accessed and/or generated by its corresponding test unit. For example, the memory may be a removable SD non-volatile memory card (not shown) of any size and capacity. As illustrated in FIG. 3, the processor 26 may be coupled with the real time clock 28, the power source 30, the wireless transceiver 32, the voltmeters 34,36, the AC/DC ammeter 38, the instant-off switch 40, and/or other components of the test units 18 through wired or wireless connections, such as a data bus (not shown), to enable information to be exchanged between the various components.

The residential or external memory of the processor 26 may be configured for storing measurements from the voltmeters 34,36 and/or the AC/DC ammeter 38, as well as the time the measurements were obtained, a power level of the power source 30, and/or data and instructions received via the wireless transceiver 32. In some embodiments of the invention, the memory may serve as a data logger, and information thereon may be wirelessly transmitted to the host computer 20 or manually retrieved at regular intervals by a user. In one example, a removable SD card of the processor 26 may be configured to store more than 6 months of data at 15 second record intervals, and may be manually removed at regular intervals of time for analysis.

In some embodiments of the invention, the processor 26 may implement a computer program and/or code segments to perform some of the functions and method described herein. The computer program may comprise an ordered listing of executable instructions for implementing logical functions in the control system. The computer program can be embodied in any computer-readable medium for use by or in connection with an instruction execution system, apparatus, or device, and execute the instructions. In the context of this application, a “computer-readable medium” can be any means that can contain or store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, an SD non-volatile memory card, and a portable compact disk read-only memory (CDROM).

As illustrated in FIG. 3, the real time clock 28 may be any real time clock 28 known in the art and may be used by the processor 26 and/or configured to control when power is provided to various elements of the test units 18 and/or when signals are transmitted by the wireless transceiver 32. For example, the test units 18 may be programmed or configured to obtain certain measurements at predetermined time intervals, tracked via the real time clock 28. Furthermore, information stored in the memory or data logger of the processor 26 may be transmitted at predetermined times or time intervals according to the real time clock 28. In some embodiments of the invention, the real-time clocks 28 of one or more of the test units 18 may be synchronized with each other and/or the cathodic system monitors 22 via radio, satellite, and/or GPS signals.

As illustrated in FIG. 3, the power source 30 may comprise any battery 50 or external power source, such as a solar power source. In some embodiments of the invention, the power source 30 may comprise one or more rechargeable NiMH batteries powered by one or more solar panels. Additionally or alternatively, connections (not shown) for an external DC power input may be provided on one or more of the test units 18. For example, an external DC power source within a range of approximately 5 V to approximately 12 V may be provided to power one or more components of the test units 18. The power source 30 may further comprise a power control circuit 52 configured to distribute an appropriate amount of power to the various electrical components of each of the test units 18.

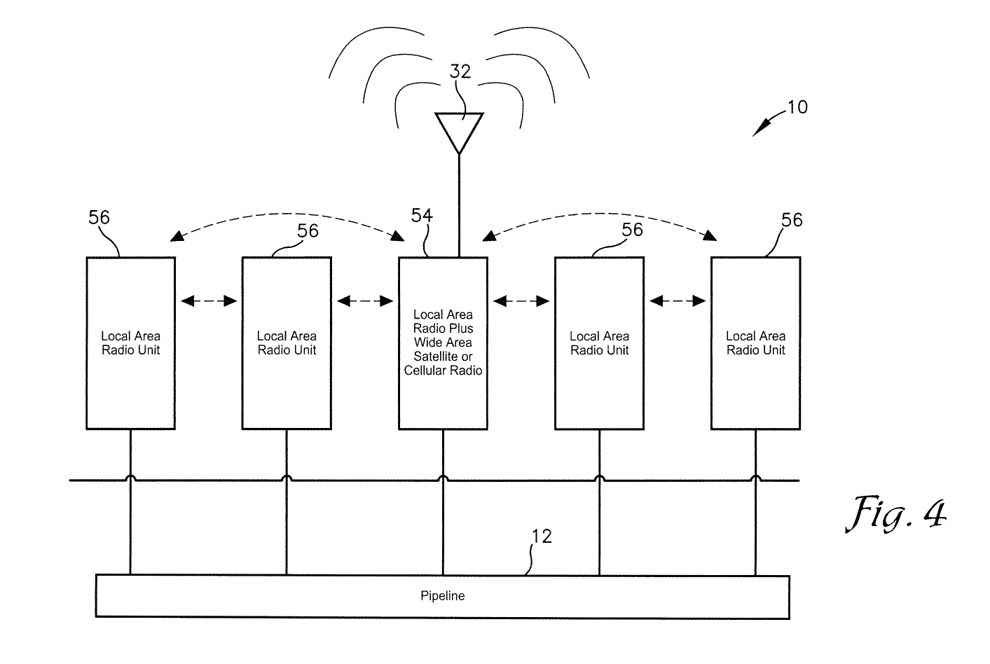

As illustrated in FIGS. 3-4, the wireless transceiver 32 in each of the test units 18 may comprise any type of apparatus or antenna configured for sending and receiving wireless signals, including one or more of: cellular signals, global system for mobile communication (GSM) signals, other radio telemetry signals, or satellite signals transmitted through the air. For example, the wireless transceiver 32 may comprise a local very high frequency (VHF) radio, a GSM modem, a satellite radio, and/or data radio, such as an RS-232 or TCP/IP data radio. The local VHF radio may comprise a provision for an external VHF whip antenna, including a spark arrester or another surge protection device.

In some embodiments of the invention, the wireless transceivers 32 of the test units 18 may be configured to communicate with each other and/or with the cathodic system monitors 22 using various communication methods described in U.S. Pat. No. 7,068,052, earlier incorporated herein. Additionally or alternatively, the wireless transceivers 32 of the test units 18 may be networked or communicatively coupled with each other in a mesh or daisy-chain configuration, such that signals from one of the test units 18 are passed along to adjacent or nearby test units 18. For example, at least some of the wireless transceivers 32 may be local area radios or mesh radios. The signals output or transmitted by the wireless transceiver 32 may be re-transmitted by other nearby wireless transceivers 32, with the signal being passed from one test unit 18 to another until it is received by one of the test units 18 or another transceiver configured for sending the signals to the Web server or host computer 20. Likewise, signals comprising data or instructions for specific ones of the test units 18 may be wirelessly transmitted via the mesh or daisy-chain-configured test units' wireless transceivers 32 until the signal is received by a desired one of the test units 18.

In some embodiments of the invention, as illustrated in FIG. 4, one or of the test units' wireless transceivers 32 may comprise or operate as a concentrator unit 54 configured to upload signals received from nearby test units 18 to the Web server or host computer 20. Test units 18 with wireless transceivers 32 only capable of short-range wireless communication, such as test units 18 with radio transceivers, may be referred to herein as field units 56. So the field units 56 may communicate over short distances with each other and with the concentrator unit 54, while the concentrator unit 54 may also communicate with the cathodic system monitor 22, host computer 20, or Web server via cellular, GSM, TCP/IP, serial, data radio, satellite, or other telemetry means for sending and receiving long-range wireless signals. The field units 56 and the concentrator unit 54 may maintain multiple wireless connection paths to maintain communication in the event that any adjacent field units 56 lose communication ability. As illustrated in FIG. 4, each test unit 18 may communicate wirelessly with multiple other test units 18 located within a particular distance from its wireless transceiver 32, and not just with adjacent ones of the test units 18. In some embodiments of the invention, there may be a predetermined number of field units 56 associated with each concentrator unit 54 that combines all readings from the field units 56 and transmits the combined readings to the host computer 20 or Web server for access by the user via a corresponding Web site. For example, a mesh or daisy-chain network of the test units 18 may have a ratio of ten field units 56 per one concentrator unit 54.

In some embodiments of the invention, if any of the test units 18 have difficulty wirelessly communicating with each other over the mesh or daisy-chain network due to terrain, a low-cost relay/repeater unit (not shown) may be installed at chosen locations (e.g., hill tops, poles, etc.) to assist in passing the signals on to the other test units 18. Note that using such a daisy-chain or mesh communication network allows monthly communication charges to only apply to concentrator units 54, since the field units 56 use free radio communication means. This may reduce operating costs of the system 10 as a whole.

As illustrated in FIG. 3, the voltmeters 34,36 may comprise autoranging circuits, digital multimeters (DMM), and the like. In one embodiment of the invention, the voltmeters 34,36 may include an AC/DC voltmeter 34 and/or a DC millivoltmeter 36. The AC/DC voltmeter 34 may be a high impedance (e.g., >100 Mohm) precision voltmeter circuit configured to measure a plurality of potentials. The reference cell 16 may be provided as positive input to the AC/DC voltmeter 34, and the pipeline 12, the secondary pipeline structure 42, the unprotected coupon 44, and/or the protected coupon 46 may be provided as negative input to the AC/DC voltmeter 34. In some embodiments of the invention, a multiplexing circuit 58 may be provided to switch between the various negative inputs configured to be connected with the AC/DC voltmeter 34. Both the AC and DC voltage components may be measured for each of the negative inputs listed above.

The DC millivoltmeter 36, illustrated in FIG. 3, may be operable to obtain higher resolution measurements in the microvolt and millivolt ranges than traditional voltmeters and may be configured to measure the voltage or current of the critical bond current shunt resistor 48. In some alternative embodiments of the invention, a single autoranging voltmeter may replace the AC/DC voltmeter 34 and the DC millivoltmeter 36 and may be configured to obtain a plurality of the voltage and current measurements described herein using various relays or multiplexers to switch between various positive and negative inputs.

The AC/DC ammeter 38, illustrated in FIGS. 2-3, may be any circuitry configured to measure a DC and AC protection or corrosion current of the pipeline 12 and/or protected coupon 46. Specifically, the AC/DC ammeter 38 may be configured to measure current flowing from the surrounding earth through the protected coupon 46 to the pipeline structure 12 using an internal shunt (not shown) to measure voltage drop across a known resistance. For example, the shunt may provide a resistance of approximately 1.8 ohms. The AC/DC ammeter 38 may measure both the AC and the DC components of this current. The measurements obtained by the AC/DC ammeter 38 may be used to calculate a corrosion current density if the effective surface area of the protected coupon 46 is known, as later described herein.

The instant-off switch 40, illustrated in FIGS. 2-3, may be any sort of switch or relay located between and configured to electrically couple the protected coupon 46 to the pipeline 12. The instant-off switch 40 may be normally closed, such that the cathodic protection applied to the pipeline 12 is also applied to the protected coupon 46. The instant-off switch 40 may be opened via instructions from the processor 26 or other test unit circuitry. For example, the instant-off switch 40 may be opened at pre-determined intervals of time for regular testing and/or may be opened based on instructions or commands transmitted by the Web server or host computer 20 to the corresponding test unit 18. Opening the instant-off switch 40 disconnects the protected coupon 46 from the pipeline structure 12, allowing an instant-off DC voltage (i.e., IR drop free potential or instant-off DC potential) of the protected coupon 46 to be measured by the AC/DC voltmeter 34. Opening the instant-off switch 40 may also allow other measurements to be obtained by the processor 26, as later described herein.

In use, the test units 18 may obtain a variety of measurements related to the pipeline's cathodic protection at each test unit's corresponding location. The measurements may be obtained by the AC/DC voltmeter 34, the DC millivoltmeter 36, and/or the AC/DC ammeter 38. The processor 26 and/or other circuitry of each test unit 18 may control switching of the inputs provided to the voltmeters 34,36 and the opening and closing of the instant-off switch 40 to interrupt current flow between the pipeline 12 and the protected coupon 46.

One or more of the following measurements may be obtained with the test units 18: DC and AC potential of the pipeline 12, DC and AC potential of the secondary pipeline structure 42, DC potential of the unprotected coupon 44, instant-off DC potential of the protected coupon 46, time to 100 mV depolarization of the pipeline 12, instant-off DC potential of the pipeline, series DC and AC corrosion current of the protected coupon 46, and DC voltage across the critical bond shunt resistor 48. Most of these measurements may be taken as often or as seldom as desired. For example, the processor 26 may be configured to obtain one or more of these measurements at 15 second intervals. The processor 26 may also be configured to store these values to be transmitted to the host computer 20 or Web server at predetermined time intervals, when instructed to by a user via the host computer 20 or Web server, or when any of the measurements obtained by the processor 26 fall outside of a predetermined acceptable range.

The DC and AC potential of the pipeline 12 may be obtained when cathodic protection is applied to the pipeline 12, with the positive input of the AC/DC voltmeter 34 connected to the pipeline 12 and the negative input of the AC/DC voltmeter 34 connected to the reference cell 16. Additionally, AC current superimposed onto the pipeline 12 by overhead high-voltage electrical transmission lines or caused by high electrical loads, a disconnected AC mitigation system, or bad grounding systems may be measured when cathodic protection is not applied to the pipeline 12. This superimposed AC voltage is generally negligible, but could be as high as approximately 100 Vac, presenting potential corrosion hazards. To measure the AC current superimposed onto the pipeline 12, the cathodic protection rectifiers 14 affecting a particular one of the test units 18 may be turned off or temporarily disconnected from the pipeline 12.

The DC and AC potential of the secondary pipeline structure 42 and DC potential of the unprotected coupon 44 may be measured by the AC/DC voltmeter 34 by switching the positive input of the voltmeter 34 from the pipeline 12 to either the secondary pipeline structure 42 or the unprotected coupon 44. This may be accomplished via the multiplexing circuit 58 or any other input-switching means known in the art. In general, these measurements can be made independently with respect to the others and it is not required to make simultaneous measurements. However, in situations where instantaneous measurements of several of the potentials or currents described herein is desired, additional voltmeters may be added to the test unit 18. The unprotected coupon 44 may provide an off-potential measurement approximately equal to the potential of the pipeline 10 when it is not cathodically protected.

Instant-off DC potential of the protected coupon 46 may be obtained by opening the instant-off switch 40 and waiting a given amount of time before taking a DC potential reading of the potential between the protected coupon 46 and the reference cell 16 using the AC/DC voltmeter 34. The given amount of time is generally in the milliseconds range, such as approximately 250 milliseconds. However, this may be a programmable parameter. In some embodiments of the invention, the DC potential of the protected coupon 46 shortly after the instant-off switch 40 is opened may be measured for approximately 10 milliseconds. Note that the instant-off potential may fall off quickly in moist soils, so timing of obtaining the instant-off DC potential may be important.

Because the protected coupon 46 normally receives the same cathodic protection current as the pipeline 12 and is buried in the same soil near the pipeline 12, the instant-off DC potential may be assumed or identified by the processor 26 or a computer program utilized by the host computer 20 or Web server as being equivalent to an instant-off DC potential of the pipeline 12. This allows the instant-off DC potential of the pipeline 12 to be determined or approximated without requiring cathodic protection current to be temporarily disconnected from the pipeline 12. Instead, opening the instant-off switch 40 merely removes cathodic protection from the protected coupon 46. This allows the test units 18 to obtain instant-off DC potential measurements without synchronizing their measurements with the cathodic system monitor 22 or cathodic protection rectifiers 14.

Once the instant-off potential measurement is taken, the processor 26 may continue measuring the protected coupon potential every Y seconds until it has dropped by X amount of mV. For example, X may be equal to approximately 100 mV. So the amount of time required for this drop to occur may be stored by the processor 26 as the time to 100 mV depolarization of the pipeline 12. The variable Y may be a pre-set or programmable value. In some embodiments of the invention, Y may be between approximately 10 msec to 10 minutes. For example, if the initial instant-off potential measurement is 900 mV, then the DC potential measured between the protected coupon 46 and the reference cell 16 may be obtained by the processor 26 via the AC/DC voltmeter 34 every Y seconds until this measurement is 800 mV. Then the processor 26 may determine how much time passed between the initial instant-off potential measurement and its X mV or 100 mV drop.

In some embodiments of the invention, a time-out period T may be required and/or stored in the processor 26. For example, the time-out period T may be programmable and may be set to any value, such as a time value in the range of approximately 1 minute to 10 days. A poorly-protected pipeline or coupon may never drop by 100 mV after its initial instant-off potential measurement, so T may specify the maximum period of time for the processor 26 to continue tracking the time it takes for the protected coupon voltage to drop by 100 mV below the initial instant-off potential measured. Note that some well-coated pipes might take days to drop to 100 mV.

In some embodiments of the invention, the test units 18 may additionally or alternatively measure the instant-off DC potential of the pipeline 12 and/or the secondary pipeline structure 42. This may require synchronization of one or more cathodic system monitors 22 and/or test units 18, such as by way of GPS synchronization signals received by the wireless transceivers 32. Specifically, measuring the instant-off DC potential directly from the pipeline 12 may require temporarily disrupting the current provided by the cathodic protection rectifiers 14 to the pipeline 12. Therefore, the test units 18 may synchronize with the cathodic system monitors 22 so that the instant-off DC potential measured from the pipeline 12 to the reference cell 16 is taken at a pre-determined time interval after cathodic protection is interrupted. It may not be necessary to measure the instant-off DC potential of both the pipeline 12 and the protected coupon 46. However, if a user already has a GPS-synchronized interruption system on their cathodic protection rectifiers 14, this method may be used instead of burying the protected coupons 46 at each test unit 18.

In some embodiments of the invention, testing both the instant-off DC potential of the pipeline 12 and the protected coupon 46 individually may allow a user to determine any offset difference between the two readings. Theoretically, the readings should be approximately the same, since both the pipeline 12 and the protected coupon 42 are receiving the same cathodic protection current up until just before the instant-off DC potential measurement is taken. However, if any difference does exist between these two measurements, an offset value may be calculated and applied to the instant-off DC potential measurement of the protected coupon 46, so that the instant-off DC potential measurement mimics the instant-off DC potential measurement of the pipeline 12 at the test unit location as closely as possible. Additionally or alternative, the cause of this offset may be further investigated and/or corrected.

The series DC and AC corrosion current of the protected coupon 46 may be determined by the AC/DC ammeter 38. Specifically, the AC/DC ammeter 38 may measure the DC protection current (or corrosion current) and the AC corrosion current flowing between the protected coupon 46 and the pipeline 12. This may be calculated by determining a voltage drop across a known ammeter resistance. As mentioned above, the measurements obtained by the AC/DC ammeter 38 may be used to calculate a corrosion current density if the size of the protected coupon 46 is known. Specifically, the processor 26 may be configured to use the AC and DC currents obtained from the AC/DC ammeter along with a predetermined or programmed surface area of the protected coupon 46 to calculate the current density of the protected coupon 46, which should approximately equal the current density of the pipeline 12 at a given test unit location. The current density may be provided in amps per square meter or any other current density units known in the art. Additionally or alternatively, the host computer 20 or Web server may be configured to calculate the corrosion current density based on the corrosion current received from one of the test units 18 and a known, stored, or user-entered surface area of the corresponding protected coupon 46.

The DC voltage across the critical bond current shunt resistor 48 may be obtained by the DC millivoltmeter 36. In some embodiments of the invention, current through the critical bond current shunt resistor 48 may be in a range from approximately 0.1 A to 200 A. Measurements obtained by the DC millivoltmeter 36 may be received or recorded by the processor 26 at predetermined intervals or when requested by the user, host computer 20, or Web server. As mentioned above, testing of the critical bond current shunt resistor 48 ensures that the corrosion mitigation processes in place continue to be effective, and verifies that the current path between the pipeline 12 and the secondary pipeline structure 42 has not been opened.

As mentioned above, the test units 18 may store readings from their voltmeters 34,36 and ammeter 38 in the processor 26 and/or any type of memory storage apparatus, such as an SD non-volatile memory card. Additionally, the stored readings or measurements may be output at predetermined intervals or when requested by a user via a corresponding Web site. Furthermore, the processor 26 of each of the test units 18 may comprise minimum and maximum measurement values for each of the measurements received by the voltmeters 34,36 and the ammeter 38. If any measurements received by the processor 26 are not within a predefined range (i.e., below the minimum or above the maximum), the processor 26 may output an alarm signal to notify the user via the Web site or any other corresponding user interfaces operable to connect to the host computer 20 or Web server, as described above. The minimum and/or maximum measurement values may be programmable by the user via the Web site or any other means, such that these values may be wirelessly received by one or more the test units 18 and initiated or updated in the processor 26 of those test units 18.

The alarm signal may be any wireless signal configured to instruct the Web server or host computer 20 to output an alarm notification to the user. For example, the alarm notification may be viewed by the user via the Web site or a Web browser, as described above, using a personal computer, laptop, mobile phone, or any other apparatus known in the art for connected to the Internet and displaying Web sites. Furthermore, an alarm notification may be relayed to a user by any communication means known in the art, such as visual or audible alarms, email, or text message to a personal mobile communication device.

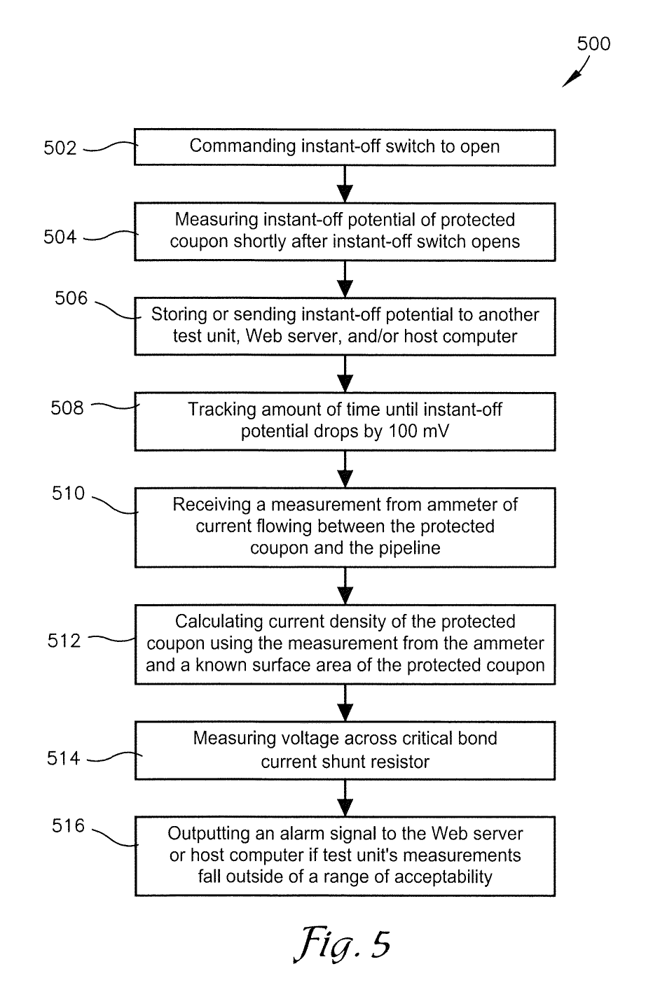

The flow chart of FIG. 5 depicts the steps of an exemplary method 500 of monitoring cathodic protection using one of the test units 18. Some of the steps of the method may be implemented with one or more of the test units 18, their processors 32, the Web server or host computer 20, and/or other components of the system 10. In some alternative implementations, the functions noted in the various blocks may occur out of the order depicted in FIG. 5. For example, two blocks shown in succession in FIG. 5 may in fact be executed substantially concurrently, or the blocks may sometimes be executed in the reverse order depending upon the functionality involved.

As illustrated in FIG. 5, the method 500 may comprise a step of commanding the instant-off switch 40 to open, as depicted in block 502. For example, the processor 26 may send a signal to the instant-off switch 40 actuating the switch to an open position, thereby interrupting current flowing from the pipeline 10 to the protected coupon 46. The method 500 may then comprise the steps of measuring instant-off potential of the protected coupon 46 shortly after the instant-off switch 40 opens, as depicted in block 504, and storing or sending this instant-off potential to another test unit 18, the Web server, and/or the host computer 20, as depicted in block 506. As described above, the instant-off potential may be potential measured between the protected coupon 46 and the reference cell 16 at a short amount of time after the instant-off switch 40 is opened, such as 100 milliseconds to 10 seconds after the instant-off switch 40 is opened.

Next, the method 500 may comprise a step of tracking an amount of time until this instant-off potential drops by a predetermined amount of time, such as approximately 100 mV, as depicted in block 508. This amount of time may also be transmitted to the Web server or host computer 20 for monitoring purposes. The method 500 may further comprise a step of receiving a measurement from the AC/DC ammeter 38 of a current flowing between the protected coupon 46 and the pipeline 12, as depicted in block 510. The measurement from the AC/DC ammeter 38 may then be used by the processor 26 and/or the Web server or host computer 20 for a step of calculating a current density of the protected coupon 46, as depicted in block 512. As described above, the current density may be calculated using the current measurement from the AC/DC ammeter 38 and a known surface area of the protected coupon 46. The method 500 may also include the steps of measuring voltage across the critical bond current shunt resistor 48, as depicted in block 514, and outputting an alarm signal if any of the test unit's measurements fall outside of a range of acceptability, as depicted in block 516.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A test unit for measuring values associated with cathodic protection of a structure, the test unit comprising:
at least one voltmeter configured to obtain a measurement of voltage between a first input and a reference cell, wherein the first input is at least one of the structure, an unprotected coupon buried next to the structure, and a protected coupon buried next to the structure;
a switch configured to electrically couple the structure and the protected coupon in a closed position and to electrically disconnect the structure from the protected coupon in an open position;
a processor communicatively coupled with the voltmeter and the switch, configured to:
command the switch to actuate from the closed position to the open position, and
store or transmit a measurement from the voltmeter of voltage between the protected coupon and the reference cell obtained at a predetermined interval of time after the switch is actuated to the open position.

2. The test unit of claim 1, wherein the predetermined interval of time is within a range of approximately 100 milliseconds to 10 seconds after the switch is actuated to the open position.

3. The test unit of claim 1, further comprising a wireless transceiver configured to output signals from the processor by way of cellular, GSM, satellite, TCP/IP, data radio, or other data telemetry signals to at least one of another test unit, a Web server, and a host computer.

4. The test unit of claim 1, wherein the processor is configured to track and determine an amount of time that passes between a point at which the processor receives a first measurement of DC voltage between the protected coupon and the reference cell after the switch is actuated to the open position and a point thereafter when the processor receives a measurement of DC voltage between the protected coupon and the reference cell that is a predefined amount of millivolts less than the first measurement.

5. The test unit of claim 1, further comprising an ammeter configured to measure at least one of AC and DC components of current flowing between the protected coupon and the structure and to transmit these current measurements to the processor.

6. The test unit of claim 5, wherein the processor is configured to calculate current density of the protected coupon using a measurement from the ammeter and a surface area of the protected coupon stored in the processor.

7. The test unit of claim 5, wherein the processor is configured to output an alarm signal if any measurements from the voltmeter or ammeter are outside of a programmed range of acceptability.

8. The test unit of claim 1, wherein the at least one voltmeter is configured to measure a DC voltage across a critical bond current shunt resistor electrically connecting the structure with a nearby secondary structure.

9. The test unit of claim 1, further comprising a switching apparatus for sequentially switching the first input of the voltmeter between the protected coupon, the unprotected coupon, and the structure.

10. The test unit of claim 9, wherein the switching apparatus is a multiplexer.

11. A system for measuring values associated with cathodic protection of a structure, the system comprising:
a plurality of test units communicatively coupled with each other, each test unit comprising:
at least one voltmeter configured to obtain measurements of voltage between a first input and a reference cell, wherein the first input is at least one of the structure, a unprotected coupon buried next to the structure, and a protected coupon buried next to the structure;
a wireless transmitter configured to send and receive signals wirelessly with at least one of other test units, a Web server, or a host computer; and
a processor communicatively coupled with the voltmeter and the wireless transmitter, and configured to receive measurements from the voltmeter, store at least some measurements received from the voltmeter, and send at least some measurements received from the voltmeter to the wireless transmitter to be communicated to the Web server or host computer,
wherein at least some of the test units are communicatively coupled in a daisy-chain or mesh radio network configuration.

12. The system of claim 11, wherein at least some of the test units comprise: a switch configured to electrically couple the structure and the protected coupon in a closed position and to electrically disconnect the structure from the protected coupon in an open position, wherein the processor is configured to command the switch to actuate from the closed position to the open position, and to store or transmit a measurement from the voltmeter of DC voltage between the protected coupon and the reference cell obtained at a predetermined interval of time after the switch is actuated to the open position.

13. The system of claim 12, wherein at least some of the test units comprise the protected coupon buried next to the structure.

14. The system of claim 11, wherein at least some of the test units are concentrator units configured to communicate via short-range wireless signals with other test units and via long-range wireless signals with the Web server or host computer, and where at least some of the test units are field units configured to only communicate via short-range wireless signals with test units in a close proximity thereto.

15. The system of claim 14, wherein the long-range wireless signals comprise cellular, GSM, satellite, TCP/IP, data radio, and other data telemetry signals, and the short-range wireless signals comprise local area radio signals or very high frequency (VHF) radio signals.

16. The system of claim 11, wherein at least some of the test units further comprising an ammeter configured to measure at least one of AC and DC components of current flowing between the protected coupon and the structure and to transmit these current measurements to the processor.

17. The system of claim 16, further comprising the Web server or host computer configured to calculate current density of the protected coupon of at least one of the test units using the measurement from the ammeter of the test unit received wirelessly by the Web server or host computer and a known surface area of the protected coupon.

18. The system of claim 16, wherein the test units are configured to output an alarm signal to the Web server or host computer if the processor receives any measurements from the voltmeter or ammeter that are outside of a programmed range of acceptability.

19. The system of claim 11, wherein at least one of the test units comprises a DC millivoltmeter communicably coupled with the processor and a critical bond current shunt resistor configured to electrically connect the structure with a nearby secondary structure, wherein the DC millivoltmeter is configured to measure a DC voltage across the critical bond current shunt resistor.

20. A method of monitoring cathodic protection of a buried pipeline at a particular point on the pipeline, the method comprising:
automatically sending a signal from a processor of a remote test unit to a switch electrically connecting the pipeline with a protected coupon buried close to the pipeline, wherein the signal is configured for instructing the switch to open, interrupting current flow between the pipeline and the protected coupon;
storing, with the processor, a measurement of voltage between the protected coupon and a reference cell taken a pre-determined interval of time after instructing the switch to open; and
transmitting the measurement of the voltage between the protected coupon and the reference cell to a Web server or host computer configured to present the measurement of the voltage between the protected coupon and the reference cell to a user via a Web browser.

21. The method of claim 21, wherein the predetermined interval of time is between approximately 100 milliseconds to 10 seconds after the switch is instructed to open.

22. The method of claim 21, wherein the step of transmitting comprises sending a signal from the processor to a wireless transceiver and transmitting the signal to one or more other test units via local area radio signals, wherein at least one of the other test units is configured to receive the signal then transmit the signal to a Web server or host computer via wide area satellite, cellular, GSM, or other telemetry signals.

23. The method of claim 21, further comprising:
continuing to receive measurements, with the processor, of voltage between the protected coupon and the reference cell after the switch is instructed to open and until the measurement received is at least approximately 100 mV less than a first measurement received after the switch is instructed to open;
tracking and determining, with the processor, an amount of time that passes between a point at which the processor receives the first measurement of voltage between the protected coupon and the reference cell after the switch is instructed to open and a point thereafter when the measurement received is at least approximately 100 mV less than the first measurement.

24. The method of claim 21, further comprising receiving, with the processor, a measurement from an ammeter of at least one of AC and DC components of current flowing between the protected coupon and the structure.

25. The method of claim 24, further comprising calculating current density of the protected coupon using the measurement from the ammeter and a surface area of the protected coupon.

26. The method of claim 21, further comprising outputting an alarm signal to the Web server or host computer if the measurement of the voltage is outside of a programmed range of acceptability.

27. The method of claim 21, further comprising measuring a DC voltage across a critical bond current shunt resistor electrically connecting the structure with a nearby secondary structure.
